(19) United States
(12) Patent Application Publication
(10) Pub. No.: US 2026/0111377 A1
(43) Pub. Date: Apr. 23, 2026

(54) METHOD AND APPARATUS OF TRANSMITTING DATA, ACCELERATOR DEVICE AND HOST

(71) Applicant: SUZHOU METABRAIN INTELLIGENT TECHNOLOGY CO., LTD., Suzhou, Jiangsu (CN)

(72) Inventors: Qi MU, Suzhou, Jiangsu (CN); Hongliang WANG, Suzhou, Jiangsu (CN); Wei LIU, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/469,035

(22) PCT Filed: Nov. 20, 2024
(86) PCT No.: PCT/CN2024/133312

§ 371 Date: Sep. 25, 2025

(30) Foreign Application Priority Data
Nov. 29, 2023 (CN) 202311608717.X

(51) Int. Cl. G06F 13/28

(52) U.S. Cl. CPC G06F 13/28; G06F 2213/28

(57) ABSTRACT

Provided are a method of transmitting data and apparatus, an accelerator device, a host, and a non-volatile readable storage medium. The method includes: receiving, by an accelerator device, an application data packet and storing the application data packet into a storage device; recording storage information of the application data packet. The storage information includes a size of the application data packet and a storage address of the application data packet in the storage device; writing the storage information of the application data packet into a descriptor, such that a host applies for memory according to the storage information in descriptor and fills an address of the memory applied into the descriptor to initiate direct memory access transmission; and transmitting, through the direct memory access transmission, the application data packet in the storage device to the host.

### CROSS-REFERENCE TO RELATED APPLICATION

This application claims priority to the Chinese Patent Application No. 202311608717.X filed to the China National Intellectual Property Administration on Nov. 29, 2023 and entitled “METHOD AND APPARATUS OF TRANSMITTING DATA, ACCELERATOR DEVICE AND HOST”, the disclosure of which is hereby incorporated by reference in its entirety.

### TECHNICAL FIELD

The present application relates to the technical field of computers, and in particular, to a method and apparatus of transmitting data, an accelerator device, a host, and a non-volatile readable storage medium.

### BACKGROUND

Direct Memory Access (DMA) has become the most common means for mass data transmission due to its performance advantages of a high transmission bandwidth, the ability to operate without a Central Processing Unit (CPU), etc. Normally, a host side applies for memory in advance, and configures a descriptor for DMA transmission. The descriptor includes information such as a data transmission length, a source address, a destination address, etc. A DMA controller initiates data transmission according to the information of the descriptor without a CPU, thereby freeing the CPU. However, in application scenarios such as network transmission, image transmission, etc., since the amount of data transmission cannot be predicted in advance, it is only possible to apply for adequate memory space on the host side in advance to prevent data packet dropouts, resulting in resource waste. In particular, in an embedded platform, due to its limited memory resource, excessive application for memory space may cause abnormalities in other functions.

Therefore, how to avoid resource waste during a direct memory access transmission process is a technical problem that needs to be solved by those skilled in the art.

### SUMMARY

The present application is intended to provide a method and apparatus of transmitting data, and an electronic device and a non-volatile readable storage medium, so as to avoid resource waste during a direct memory access transmission process.

In order to implement the above objective, a first aspect of embodiments of the present application provides a method of transmitting data, which is applied to an accelerator device. The accelerator device is connected with a host. The method includes:
receiving an application data packet, and storing the application data packet into a storage device;
recording storage information of the application data packet, wherein the storage information includes a size of the application data packet and a storage address of the application data packet in the storage device;
writing the storage information of the application data packet into a descriptor, such that the host applies for memory according to the storage information in the descriptor, and fills an address of the memory applied into the descriptor to initiate direct memory access transmission; and
transmitting, through the direct memory access transmission, the application data packet in the storage device to the host according to the address of the memory applied in the descriptor filled by the host.

The receiving an application data packet, and storing the application data packet into a storage device includes:
receiving an application data packet;
pre-processing the application data packet, wherein the pre-processing includes any one or any combination of analog-to-digital conversion, data filtering, and image decompression and compression; and
storing the pre-processed application data packet into the storage device.

The receiving an application data packet includes:
receiving application data packets through a plurality of data channels.

The pre-processing the application data packet includes:
pre-processing the application data packets, received through the plurality of data channels, in parallel by a plurality of data pre-processing modules.

The writing the storage information of the application data packet into a descriptor, such that the host applies for memory according to the storage information in the descriptor, and fills an address of the memory applied into the descriptor to initiate direct memory access transmission includes:
determining a target descriptor among descriptors whose states are in an idle state, writing the storage information of the application data packet into the target descriptor, and modifying a state of the target descriptor to an occupied state, such that the host applies for the memory according to the size of the application data packet in the target descriptor, and fills the address of the memory applied into the target descriptor to initiate the direct memory access transmission.

After transmission of the application data packet is completed, the host modifies the state of the target descriptor to the idle state.

After modifying the state of the target descriptor to the occupied state, the method further includes:
updating a descriptor count, and transmitting the descriptor count to the host, wherein the descriptor count is configured to describe a number of descriptors whose states are in the occupied state.

The host cyclically queries the descriptor count, if the descriptor count is not zero, the host reads the target descriptor, and performs a step of applying for the memory according to the size of the application data packet in the target descriptor.

After the host modifies the state of the target descriptor to the idle state, the host updates the descriptor count according to the number of descriptors whose states are in the occupied state.

The writing the storage information of the application data packet into a descriptor includes: after receiving each application data packet and storing the each application data packet into the storage device, writing the storage information of the each application data packet into the descriptor.

The storage device is divided into a plurality of storage blocks. The storing the application data packet into the storage device includes:
sequentially storing the application data packets into the storage blocks in the storage device. the writing the storage information of the application data packet into a descriptor includes:
after the filling of each storage block is completed, writing, into the descriptor, the storage information of the application data packet in the filled storage block, wherein the storage information of each application data packet corresponds to one descriptor.

The accelerator device includes a field programmable gate array and the storage device, the field programmable gate array includes a data caching module, a data transmission control module, a storage controller, a reading and writing module, and a direct memory access module.
the data caching module is configured to cache the application data packet received.
the storage controller is configured to store the application data packet cached into the storage device.
the data transmission control module is configured to record the storage information of the application data packet, and write the storage information of the application data packet into the descriptor through the reading and writing module.
the reading and writing module is configured to perform information transmission with the host.
the direct memory access module is configured to transmit the application data packet in the storage device to the host according to the address of the memory applied in the descriptor filled by the host.

The field programmable gate array further includes a data pre-processing module, and the data pre-processing module is configured to pre-process the application data packet received.

The accelerator device further includes a data pre-processing module independent of the field programmable gate array; the data pre-processing module is connected with the field programmable gate array; and the data pre-processing module is configured to pre-process the application data packet received.

The storage device is a double data rate synchronous dynamic random access memory.

In order to achieve the above objective, a second aspect of the embodiments of the present application provides an apparatus of transmitting data, which is applied to an accelerator device. The accelerator device is connected with a host. The apparatus includes:
a storage module, configured to receive an application data packet, and store the application data packet into a storage device;
a recording module, configured to record storage information of the application data packet, wherein the storage information includes a size of the application data packet and a storage address of the application data packet in the storage device;
a writing module, configured to write the storage information of the application data packet into a descriptor, such that the host applies for memory according to the storage information in the descriptor, and fills an address of the memory applied into the descriptor to initiate direct memory access transmission; and
a transmission module, configured to transmit, through the direct memory access transmission, the application data packet in the storage device to the host according to the address of the memory applied in the descriptor filled by the host.

In order to achieve the above objective, a third aspect of the embodiments of the present application provides an accelerator device, comprising:
a storage device, configured to store a computer program; and
a processor, configured to implement, when executing the computer program, steps of the method of transmitting data described above.

In order to achieve the above objective, the present application provides a non-volatile computer-readable storage medium. The non-volatile computer-readable storage medium stores a computer program thereon. The computer program, when executed by a processor, implements steps of the method of transmitting data described above.

In order to achieve the above objective, a fourth aspect of the embodiments of the present application provides a method of transmitting data, which is applied to a host. The host is connected with an accelerator device. The method includes:
acquiring a descriptor, and applying for memory according to storage information in the descriptor, wherein the storage information includes a size of an application data packet to be transmitted and a storage address of the application data packet in a storage device of the accelerator device;
filling an address of the memory applied into the descriptor to initiate direct memory access transmission; and
receiving the application data packet sent by the accelerator device.

Before acquiring the descriptor, the method further includes:
querying a descriptor count, and if the descriptor count is not zero, turning to the step of acquiring the descriptor, and applying for the memory according to the storage information in the descriptor.

Before the acquiring a descriptor, the method further includes:
applying for descriptor storage space by accessing the applied memory through direct memory access.

In order to achieve the above objective, the present application provides an apparatus of transmitting data, which is applied to a host. The host is connected with an accelerator device. The apparatus includes:
a first application module, configured to acquire a descriptor, and apply for memory according to storage information in the descriptor, wherein the storage information includes the size of an application data packet to be transmitted and a storage address of the application data packet in a storage device of the accelerator device;
an initiation module, configured to fill an address of the memory applied into the descriptor to initiate direct memory access transmission; and
a receiving module, configured to receive the application data packet sent by the accelerator device.

In order to achieve the above objective, a fifth aspect of the embodiments of the present application provides a host, comprising:
a storage device, configured to store a computer program; and
a processor, configured to implement, when executing the computer program, steps of the method of transmitting data described above.

In order to achieve the above objective, a sixth aspect of the embodiments of the present application provides a non-volatile computer-readable storage medium. The non-volatile computer-readable storage medium stores a computer program thereon. The computer program, when executed by a processor, implements steps of the method of transmitting data described above.

In order to achieve the above objective, a seventh aspect of the embodiments of the present application provides a system of transmitting data, comprising the accelerator device described above and the host described above, and the host is connected with the accelerator device.

By means of the solutions above, it can be known that, the method of transmitting data provided in the present application includes: receiving, by the accelerator device, the application data packet and storing the application data packet into the storage device; recording the storage information of the application data packet, wherein the storage information includes the size of the application data packet and the storage address of the application data packet in the storage device; writing the storage information of the application data packet into a descriptor, such that the host applies for memory according to the storage information in the descriptor, and fills the address of the memory applied into the descriptor to initiate direct memory access transmission; and transmitting, through the direct memory access transmission, the application data packet in the storage device to the host according to the address of the memory applied in the descriptor filled by the host.

By means of the method of transmitting data provided in the present application, the accelerator device needs to writes the storage information of the application data packet to be transmitted into the descriptor, DMA transmission is initiated by the host, and the corresponding memory space is applied according to the storage information in the descriptor without creating a large amount of memory space in advance, such that the requirement for CPU performance is reduced, and meanwhile, the real-time performance of data transmission may be ensured. Thus, it can be seen that, the method of transmitting data provided in the present application avoids resource waste during a direct memory access transmission process. Further provide in the present application are an apparatus transmitting data, an accelerator device, a host, and a non-volatile computer-readable storage medium, which can also achieve the technical effects described above.

It should be understood that, the general description above and the following detailed description are merely exemplary, and do not constitute a limitation to the present application.

### BRIEF DESCRIPTION OF THE DRAWINGS

The drawings to be used in description of embodiments or prior art will be briefly introduced below in order to describe the technical solutions in the embodiments of the present application or prior art more clearly. Apparently, the drawings described below are merely some embodiments of the present application. Those of ordinary skill in the art may obtain other drawings according to these drawings without paying creative work. The drawings are used to provide an understanding of the present disclosure, and constitute a part of the description, which are used to explain the present disclosure with the following optional implementations, and do not constitute a limitation to the present disclosure. In the drawings:

FIG. 1 is a flowchart of a method of transmitting data according to an exemplary embodiment;

FIG. 2 is a block diagram of a storage device according to an exemplary embodiment;

FIG. 3 is a structural diagram of an apparatus of transmitting data according to an exemplary embodiment;

FIG. 4 is a structural diagram of an accelerator device according to an exemplary embodiment;

FIG. 5 is a structural diagram of another accelerator device according to an exemplary embodiment;

FIG. 6 is a structural diagram of yet another accelerator device according to an exemplary embodiment;

FIG. 7 is a flowchart of another method of transmitting data according to an exemplary embodiment;

FIG. 8 is a structural diagram of an apparatus of transmitting data according to an exemplary embodiment;

FIG. 9 is a structural diagram of a host according to an exemplary embodiment;

FIG. 10 is a structural diagram of a system of transmitting data according to an exemplary embodiment;

FIG. 11 is a structural diagram of another system of transmitting data according to an exemplary embodiment; and

FIG. 12 is a flowchart of a method of transmitting data according to an application embodiment provided by the present application.

### DETAILED DESCRIPTION OF THE EMBODIMENTS

The technical solutions in the embodiments of the present application will be clearly and completely described below with reference to the drawings in the embodiments of the present application. It is apparent that the embodiments described are merely part of the embodiments of the present application, rather than all of them. All the other embodiments obtained by those of ordinary skill in the art based on the embodiments in the present application without creative effort shall fall within the scope of protection of the present application. In addition, in the embodiments of the present application, terms “first”, “second” and the like are used for distinguishing similar objects rather than describing a specific sequence or a precedence order.

Provided in the embodiments of the present application is a method of transmitting data, so as to avoid resource waste during a direct memory access transmission process.

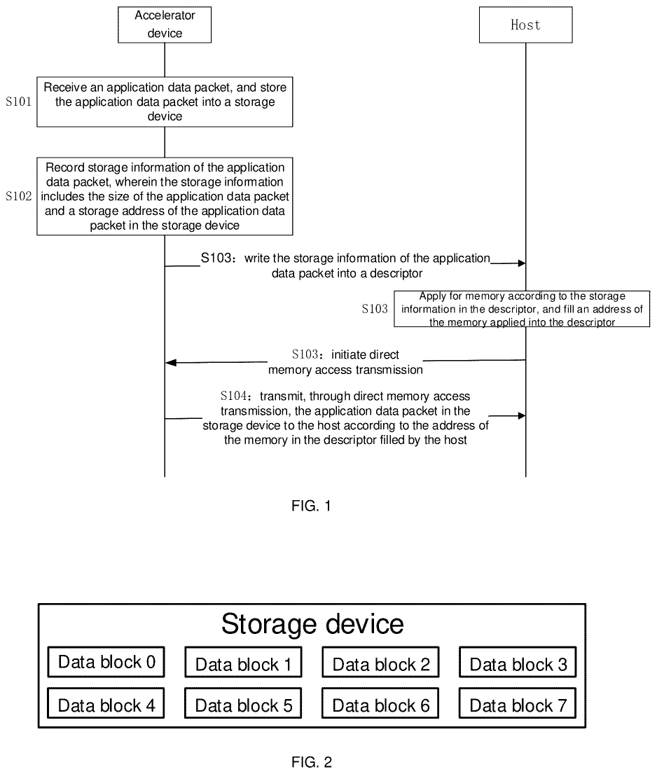

Referring to FIG. 1, a flowchart of a method of transmitting data according to an exemplary embodiment is shown in FIG. 1, the method includes the following steps.

S101: receive an application data packet, and store the application data packet into a storage device.

An execution entity of the embodiments of the present application is an accelerator device, such as a Field Programmable Gate Array (FPGA) accelerator device. The accelerator device is connected with a host. The embodiments of the present application may be applied to parallel application scenarios such as multi-channel Analog-Digital (AD) conversion, multi-channel image input, etc.

In an actual implementation, the accelerator device receives an application data packet and stores the application data packet into the storage device. The storage device herein may be a Double Data Rate (DDR) synchronous dynamic random access memory or other types of memories, and is not limited herein.

As an optional implementation, receiving an application data packet, and storing the application data packet into a storage device includes: receiving the application data packet; pre-processing the application data packet, wherein the pre-processing includes any one or any combination of analog-to-digital conversion, data filtering, and image decompression and compression; and storing the pre-processed application data packet into the storage device.

In practical implementation, after receiving the application data packet, the accelerator device performs pre-processes on the application data packet, the pre-processing may include analog-to-digital conversion, data filtering, image decompression and compression, etc. A pre-processing algorithm may be developed according to an actual application. Then, the pre-processed application data packet is stored into the storage device. Thus, it can be seen that, performing the pre-processing process of the application data packet in the accelerator device may effectively relieve data processing pressure of a host CPU, thereby improving the performance of a system of transmitting data.

As a feasible implementation, receiving the application data packet includes: receiving application data packets through a plurality of data channels. Correspondingly, pre-processing the application data packet includes: pre-processing the application data packets, received through the plurality of data channels, in parallel by a plurality of data pre-processing modules. In practical implementation, the accelerator device may parallelly receive the application data packet by the plurality of data channels, and the plurality of data pre-processing modules may parallelly pre-processes the application data packet received by the plurality of data channels, so as to improve data processing efficiency.

As a feasible implementation, storing the application data packet into a storage device includes: caching the application data packet, and storing the application data packet cached into the storage device. In actual implementation, the accelerator device first caches the pre-processed application data packet, and then packs and writes the pre-processed application data packet into the storage device.

S102: record storage information of the application data packet, wherein the storage information includes the size of the application data packet and a storage address of the application data packet in the storage device.

In actual implementation, the accelerator device records the storage information of the application data packet, the storage information of the application data packet includes the size of the application data packet and the storage addresses of the application data packet in the storage device.

S103: write the storage information of the application data packet into a descriptor, such that the host applies for memory according to the storage information in the descriptor, and fills an address of the memory applied into the descriptor to initiate direct memory access transmission.

In actual implementation, the accelerator device writes the storage information of the application data packet into the descriptor prepared in advance by the host. The descriptor is a host-side memory with a fixed size, which has been prepared in advance by the host before data transmission and may store up to 256 pieces of transmission information. The descriptor is in an idle state when it is empty, and is in an occupied state when it is filled with data. One descriptor is occupied by each transmission, and may be recycled. The host applies for the memory according to the storage information in the description information, and fills the address of the memory applied into the descriptor. The host initiates a data transmission operation, that is, initiating direct memory access transmission.

As a feasible implementation, writing the storage information of the application data packet into a descriptor, such that the host applies for memory according to the storage information in the descriptor, and filling the address of the memory applied into the descriptor to initiate direct memory access transmission includes: determining a target descriptor among descriptors whose states are in an idle state, writing the storage information of the application data packet into the target descriptor, and modifying the state of the target descriptor to an occupied state, such that the host applies for the memory according to the size of the application data packet in the target descriptor, and fills the address of the memory applied into the target descriptor to initiate direct memory access transmission. After transmission of the application data packet is completed, the host modifies the state of the target descriptor to an idle state.

In actual implementation, the target descriptor is determined among the descriptors whose states are in an idle state, the storage information of the application data packet is written into the target descriptor, and the state of the target descriptor is modified to an occupied state. The host applies for the memory according to the size of the application data packet in the descriptor, and fills the address of the memory applied into the target descriptor to initiate direct memory access transmission. After transmission of the application data packet is completed, the host modifies the state of the target descriptor to an idle state.

As a feasible implementation, writing the storage information of the application data packet into a descriptor includes: writing the storage information of the application data packet into the descriptor after each application data packet is stored into the storage device. In actual implementation, for an application with a high real-time requirement, after each application data packet is stored into the storage device, the storage information of the application data packet is immediately written into the descriptor.

As another feasible implementation, the storage device is divided into a plurality of storage blocks. Storing the storage information of the application data packet into the descriptor includes: after the filling of each storage block is completed, writing, the storage information of the application data packet in the storage block into the descriptor. In actual implementation, for an application with a low real-time requirement, the storage device is divided into storage blocks, and after each data block is filled, the storage information of the application data packet therein is filled into the descriptor. For example, as shown in FIG. 2, the memory space is divided into 8 data blocks 0-7. The data blocks are sequentially filled from the data block 0. After each data block is filled, the storage information of the application data packet in the data block is filled into the descriptor, so as to notify the host side that data reading may be performed. In an application scenario with a low real-time requirement, frequent initiation of a DMA data reading operation by the host side is avoided, thereby ensuring the stability of the system of transmitting data.

As an optional implementation, after writing the storage information of the application data packet into the descriptor, the method further includes: updating a descriptor count, and transmitting the descriptor count to the host, wherein the descriptor count is configured to describe the number of descriptors whose states are in an occupied state. The host cyclically queries the descriptor count, reads a target descriptor count if the descriptor count is not zero, and performs the step of applying for memory according to the size of the application data packet in the target descriptor. After the host modifies the state of the target descriptor to an idle state, the host updates the descriptor count according to the number of descriptors whose states are in an occupied state.

In actual implementation, the accelerator device counts the stored application data packets. After each application data packet is stored, the storage information of the application data packet occupies one descriptor, and after each descriptor is filled, the descriptor count is added by one. That is, the stored application data packets are counted by counting the number of the descriptors whose states are in an occupied state, and the descriptor count is uploaded to the host side to notify the host side of the number of the descriptors that may be currently processed. The host cyclically queries the descriptor count, and applies for memory according to the storage information in the description information if the descriptor count is not zero. After the transmission of the application data packet is completed, the host updates the descriptor count according to the number of the descriptors of whose states are in an occupied state, that is, the descriptor count is subtracted by one. It is to be noted that, while updating the descriptor count, the host side and the accelerator device side also need to update a head pointer and a tail pointer of the descriptor.

S104: transmit, through direct memory access transmission, the application data packet in the storage device to the host according to the address of the memory in the descriptor filled by the host.

In actual implementation, the accelerator device transmits, through DMA transmission, the application data packet to the host according to the address of the memory applied by the host, and the host waits for completion of receiving and transmission, and then ends the operation.

By means of the method of transmitting data provided in the embodiments of the present application, the accelerator device writes the storage information of the application data packet to be transmitted into the descriptor. DMA transmission is initiated by the host, and the corresponding memory space is applied according to the storage information in the descriptor without creating a large amount of storage space in advance, such that it may be possible to reduce the requirement for CPU performance, and ensure the real-time performance of data transmission. Thus, it can be seen that, the method of transmitting data provided in the embodiments of the present application may avoid resource waste during a direct memory access transmission process.

An apparatus of transmitting data provided in the embodiments of the present application is introduced below. The apparatus of transmitting data described below and the method of transmitting data described above may be referred to each other.

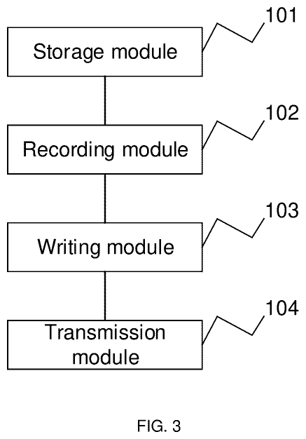

Referring to FIG. 3, a structural diagram of an apparatus of transmitting data according to an exemplary embodiment is shown in FIG. 3, the apparatus includes:
a storage module 101, configured to receive an application data packet, and store the application data packet into a storage device;
a recording module 102, configured to record storage information of the application data packet, wherein the storage information includes the size of the application data packet and a storage address of the application data packet in the storage device;
a writing module 103, configured to write the storage information of the application data packet into a descriptor, such that the host applies for memory according to the storage information in the descriptor, and fills the address of the memory applied into the descriptor to initiate direct memory access transmission; and
a transmission module 104, configured to transmit, through direct memory access transmission, the application data packet in the storage device to the host according to the address of the memory applied in the descriptor filled by the host.

In the embodiments of the present application, the accelerator device writes the storage information of the application data packet to be transmitted into the descriptor, DMA transmission is initiated by the host, and the corresponding memory space is applied according to the storage information in the descriptor without creating a large amount of memory space in advance, such that the requirement for CPU performance may be reduced, and meanwhile, the real-time performance of data transmission may be ensured. Thus, it can be seen that, the embodiments of the present application avoid resource waste during a direct memory access transmission process.

On the basis of the embodiments above, as an optional implementation, the storage module 101 is configured to: receive an application data packet; pre-process the application data packet, wherein the pre-processing includes any one or any combination of analog-to-digital conversion, data filtering, and image decompression and compression; and store the application data packet pre-processed into the storage device.

On the basis of the embodiments above, as an optional implementation, the storage module 101 is configured to: receive the application data packet by a plurality of data channels; and parallelly pre-process, by a plurality of data pre-processing modules, the application data packet received by the plurality of data channels.

On the basis of the embodiments above, as an optional implementation, the writing module 103 is configured to: determine a target descriptor among descriptors whose states are in an idle state, write the storage information of the application data packet into the target descriptor, and modify the state of the target descriptor to an occupied state, such that the host applies for memory according to the size of the application data packet in the target descriptor, and fills the address of the memory applied into the target descriptor to initiate direct memory access transmission.

On the basis of the embodiments above, as an optional implementation, after transmission of the application data packet is completed, the host modifies the state of the target descriptor to an idle state.

On the basis of the embodiments above, as an optional implementation, the writing module 103 is configured to: after receiving each application data packet and storing each application data packet into the storage device, write the storage information of the application data packet into the descriptor.

On the basis of the embodiments above, as an optional implementation, the storage device is divided into a plurality of storage blocks. The storage module 101 is configured to: sequentially store the application data packets into the storage blocks in the storage device. The writing module 103 is configured to: write the storage information of the application data packet in the filled storage block into the descriptor after the filling of each storage block is completed, wherein the storage information of each application data packet corresponds to one descriptor.

On the basis of the embodiments above, as an optional implementation, the method further includes:
updating a descriptor count, and transmitting the descriptor count to the host, wherein the descriptor count is configured to describe the number of descriptors whose states are in an occupied state.

On the basis of the embodiments above, as an optional implementation, the host cyclically queries the descriptor count, reads a target descriptor count if the descriptor count is not zero, and performs the step of applying for memory according to the size of the application data packet in the target descriptor. After the host modifies the state of the target descriptor to an idle state, the descriptor count is updated according to the number of descriptors whose states are in an occupied state.

On the basis of the embodiments above, as an optional implementation, the accelerator device includes a field programmable gate array and the storage device, and the field programmable gate array includes a data caching module, a data transmission control module, a storage controller, a reading and writing module, and a direct memory access module.

The data caching module is configured to cache the application data packet received.

The storage controller is configured to store the application data packet cached into the storage device.

The data transmission control module is configured to record the storage information of the application data packet, and write the storage information of the application data packet into the descriptor through the reading and writing module.

The reading and writing module is configured to perform information transmission with the host.

The direct memory access module is configured to transmit the application data packet in the storage device to the host according to the address of the memory in the descriptor filled by the host.

On the basis of the embodiments above, as an optional implementation, the field programmable gate array further includes a data pre-processing module, and the data pre-processing module is configured to pre-process the application data packet received.

On the basis of the embodiments above, as an optional implementation, the accelerator device further includes a data pre-processing module independent of the field programmable gate array; the data pre-processing module is connected with the field programmable gate array; and the data pre-processing module is configured to pre-process the application data packet received.

On the basis of the embodiments above, as an optional implementation, the storage device is a double data rate synchronous dynamic random access memory.

Regarding the apparatus in the embodiments above, the execution manners of all modules have been described in detail in the embodiments related to the method, and details will not be described herein again.

Provided in the embodiments of the present application is an accelerator device, including:
a storage device, configured to store a computer program; and
a processor, configured to implement, when executing the computer program, steps of the method of transmitting data described above.

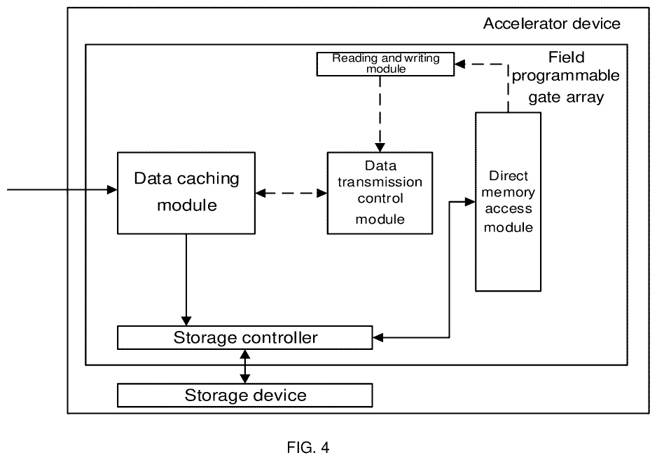

As an optional embodiment, as shown in FIG. 4, the accelerator device includes a field programmable gate array and a storage device. The field programmable gate array includes a data caching module, a data transmission control module, a storage controller, a reading and writing module, and a direct memory access module. The data caching module is configured to cache the application data packet received. The storage controller is configured to store the application data packet cached into the storage device. The data transmission control module is configured to record the storage information of the application data packet, and write the storage information of the application data packet into the descriptor. The reading and writing module is configured to perform information transmission with the host. The direct memory access module is configured to transmit the application data packet in the storage device to the host to the host according to the address of the memory in the descriptor filled by the host.

In actual implementation, the data caching module is configured to first cache the pre-processed data packet, and the storage controller is configured to pack and write cached data into the storage device. The transmission control module is configured to record the size of the application data packet and the address of the memory the application data packet in the storage device, and write the information (the size of the application data packet and the address of the memory the application data packet in the storage device) into the descriptor prepared in advance by the host. The transmission control module is further configured to count the data packets, and upload, by the reading and writing module, a descriptor count value (i.e., number of descriptors) to the host side to notify the host side of the number of the descriptors that may currently be processed, wherein the descriptors are recycled. The reading and writing module is responsible for information transmission between the reading and writing module and the accelerator device. For example, the accelerator device may notify, by the reading and writing module, the host of the number of descriptors that may currently be operated, that is, a descriptor count. The direct memory access module is configured to receive the descriptor that has been filled by the accelerator device; and then the host side applies for memory, completes the filling of the descriptor, and initiates a data transmission operation.

The storage device in the embodiments of the present application may be a DDR, or may also be other types of storage device, which is not limited herein.

Optionally, the accelerator device further includes a data pre-processing module, which is configured to pre-process the application data packet received, for example, pre-process data sent by parallel applications such as multi-channel Analog-to-Digital Converter (ADC) conversion, image transmission, etc., such as ADC conversion, data filtering, image decompression and compression, etc. A processing algorithm may be developed according to an actual application. The parallel data processing process is performed in an FPGA accelerator, such that the data processing pressure of a CPU may be effectively relieved, thereby improving the performance of the system.

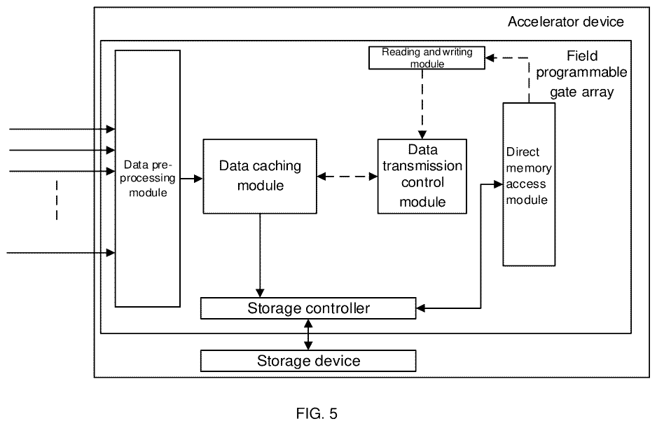

As a feasible implementation, the field programmable gate array further includes a data pre-processing module, and the data pre-processing module is configured to pre-process the application data packet received. In actual implementation, as shown in FIG. 5, the data pre-processing module is located in the field programmable gate array.

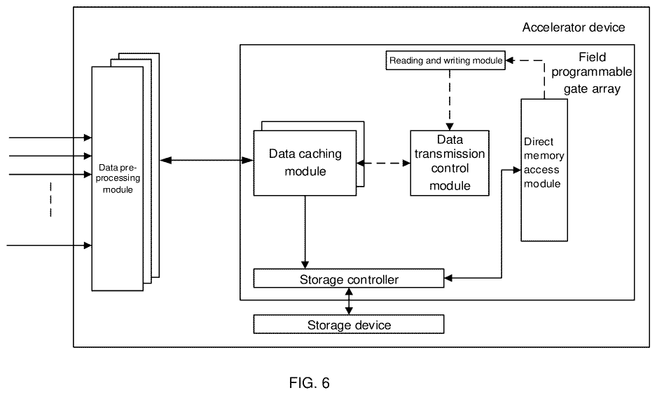

As another feasible implementation, the accelerator device further includes a data pre-processing module independent of the field programmable gate array; the data pre-processing module is connected with the field programmable gate array; and the data pre-processing module is configured to pre-process the application data packet received. In actual implementation, as shown in FIG. 6, the data pre-processing module is independent of the field programmable gate array. A data receiving and pre-processing module is constructed by selecting a scenario-oriented dedicated device, for example, RK3399 is specifically used for image processing. The dedicated data pre-processing module transmits a processed result to the field programmable gate array via interfaces such as Peripheral Component Interconnect Express (PCIe) or Secure Digital Input and Output (SDIO), etc. The field programmable gate array only performs data caching and forwarding. The dedicated data pre-processing module may effectively improve data pre-processing efficiency, and reduce FPGA development difficulty, thereby improving the overall efficiency of the system.

In the embodiments of the present application, the accelerator device writes the storage information of the application data packet to be transmitted into the descriptor, DMA transmission is initiated by the host, and the corresponding memory space is applied according to the storage information in the descriptor without creating a large amount of memory space in advance, such that the requirement for CPU performance is reduced, and meanwhile, the real-time performance of data transmission may be ensured. Thus, it can be seen that, the embodiments of the present application avoid resource waste during a direct memory access transmission process.

Provided in the embodiments of the present application is a method of transmitting data, which may avoid resource waste during a direct memory access transmission process.

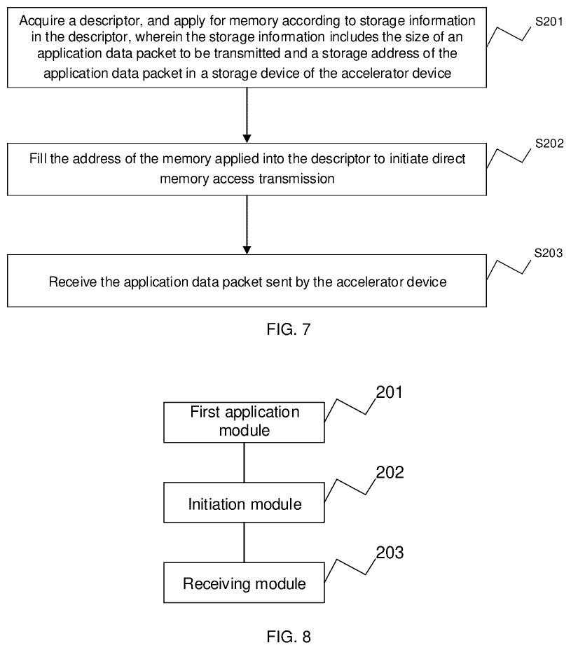

Referring to FIG. 7, a flowchart of another method of transmitting data according to an exemplary embodiment is shown in FIG. 7, and the method includes the following steps.

S201: acquire a descriptor, and apply for memory according to storage information in the descriptor, wherein the storage information includes the size of an application data packet to be transmitted and a storage address of the application data packet in a storage device of the accelerator device.

An execution entity of the embodiment of the present application is a host, and the host is connected with an accelerator device. The embodiments of the present application may be applied to parallel application scenarios such as multi-channel AD conversion, multi-channel image input, etc.

As a feasible implementation, before acquiring the descriptor, the method further includes: applying for descriptor memory space by means of direct memory access (DMA) coherent memory. In actual implementation, the host first applies for descriptor memory space through DMA coherent memory, and starts the system.

In practical implementation, the accelerator device receives the application data packet, stores the application data packet into the storage device, records the storage information of the application data packet, and writes the storage information into the descriptor. The host applies for the memory according to the size of the application data packet that needs to be transmitted in the storage information in the description information.

As an optional embodiment, before acquiring the descriptor, the method further includes: querying a descriptor count, and turning to the step of acquiring the descriptor, and applying for memory according to the storage information in the descriptor if the descriptor count is not zero.

In actual implementation, the accelerator device counts the received application data packets, that is, the accelerator device counts the received application data packets by means of the descriptor count, and uploads the descriptor count to the host side to notify the host side of the number of the descriptors that may currently be processed. The host cyclically queries the descriptor count, and applies for memory according to the storage information in the description information if the descriptor count is not zero.

S202: fill the address of the memory applied into the descriptor to initiate direct memory access transmission.

In actual implementation, the host fills the address of the memory applied into the descriptor. The host initiates a data transmission operation, that is, initiates direct memory access transmission.

S203: receive the application data packet sent by the accelerator device.

In actual implementation, the host waits for completion of transmission of the application data packet, so as to end the operation.

In the embodiments of the present application, the accelerator device writes the storage information of the application data packet to be transmitted into the descriptor, DMA transmission is initiated by the host, and the corresponding memory space is applied for according to the storage information in the descriptor without creating a large amount of memory space in advance, such that the requirement for CPU performance is reduced, and meanwhile, the real-time performance of data transmission may be ensured. Thus, it can be seen that, the embodiments of the present application avoid resource waste during a direct memory access transmission process.

An apparatus of transmitting data provided in the embodiments of the present application is introduced below. The apparatus of transmitting data described below and the method of transmitting data described above may be referred to each other.

Referring to FIG. 8, a structural diagram of an apparatus of transmitting data according to an exemplary embodiment is shown in FIG. 8, the apparatus includes:
a first application module 201, configured to acquire a descriptor, and apply for memory according to storage information in the descriptor, wherein the storage information includes the size of an application data packet to be transmitted and a storage address of the application data packet in a storage device of the accelerator device;
an initiation module 202, configured to fill the address of the memory applied into the descriptor to initiate direct memory access transmission; and
a receiving module 203, configured to receive the application data packet sent by the accelerator device.

In the embodiments of the present application, the accelerator device writes the storage information of the application data packet to be transmitted into the descriptor, DMA transmission is initiated by the host, and the corresponding memory space is applied according to the storage information in the descriptor without creating a large amount of memory space in advance, such that the requirement for CPU performance is reduced, and meanwhile, the real-time performance of data transmission may be ensured. Thus, it can be seen that, the embodiments of the present application avoid resource waste during a direct memory access transmission process.

On the basis of the embodiments above, as an optional implementation, the apparatus further includes:
a query module, configured to query a descriptor count, and initiate a workflow of the first application module 201 if the descriptor count is not zero.

On the basis of the embodiments above, as an optional implementation, the apparatus further includes:
a second application module, configured to apply for descriptor memory space by means of direct memory access coherent memory.

Regarding the apparatus in the embodiments above, the execution manners of all modules have been described in detail in the embodiments related to the method, and details will not be described herein again.

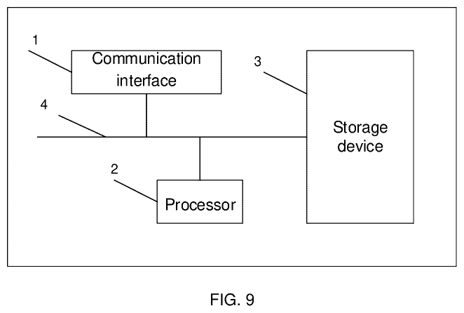

On the basis of the hardware implementation of the program modules above, and in order to implement the method of the embodiments of the present application, an embodiment of the present application further provides a host. FIG. 9 is a structural diagram of a host according to an exemplary embodiment. As shown in FIG. 9, the host includes:
a communication interface 1, configured to perform information interaction with other devices such as a network device; and
a processor 2, connected with the communication interface 1 to achieve information interaction with other devices, and configured to, when executing a computer program, perform the method of transmitting data provided by one or more technical solutions above. The computer program is stored in a storage device 3.

Definitely, in practical applications, the various components in the host are coupled together via a bus system 4. It can be understood that, the bus system 4 is configured to achieve connection communication among these components. In addition to a data bus, the bus system 4 further includes a power bus, a control bus, and a state signal bus. However, for the sake of clarity, the various buses are labeled as the bus system 4 in FIG. 9.

The storage device 3 in the embodiments of the present application is configured to store various types of data to support the operations of the host. Examples of these data include any computer program that is configured to be operated on the host.

The processor 2, when executing the program, implements corresponding steps in the methods of the embodiments of the present application. For simplicity, elaborations are omitted herein.

In an exemplary embodiment, an embodiment of the present application further provides a non-volatile readable storage medium (i.e., a non-volatile computer-readable storage medium), which may be a non-volatile computer-readable storage medium, for example, a memory storing the computer program. The computer program above may be executed by the processor to perform the steps of the method of transmitting datas of the accelerator device side and the host side described above. The non-volatile computer-readable storage medium may be a memory such as a Ferroelectric Random Access Memory (FRAM), a Read-Only Memory (ROM), a Programmable Read-Only Memory (PROM), an Erasable Programmable Read-Only Memory (EPROM), an Electrically Erasable Programmable Read-Only Memory (EEPROM), a Flash Memory, a magnetic surface memory, an optical disc, a Compact Disc Read-Only Memory (CD-ROM), etc.

Provided in the embodiments of the present application is a system of transmitting data, which includes the accelerator device provided in the embodiments above and the host provided in the embodiments above. The host is connected with the accelerator device. The accelerator device may be connected with the host via a PCIe hardcore module.

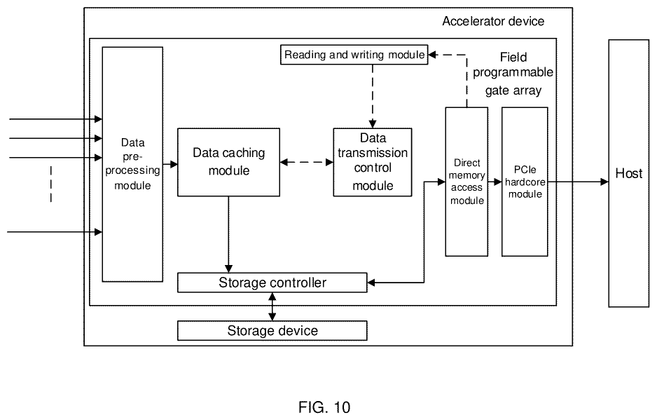

As a feasible implementation, the data pre-processing module is located in a field programmable gate array, and the system of transmitting data is shown in FIG. 10.

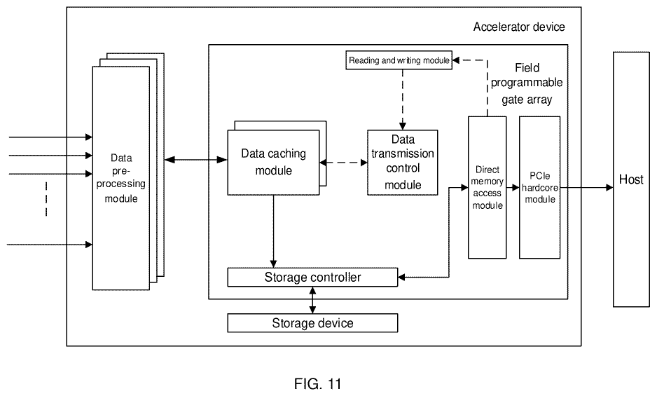

As another feasible implementation, the data pre-processing module is independent of the field programmable gate array, and the system of transmitting data is shown in FIG. 11. A data receiving and pre-processing module is constructed by selecting a scenario-oriented dedicated device, for example, RK3399 is specifically used for image processing. The dedicated data pre-processing module transmits a processed result to the field programmable gate array via interfaces such as PCIe or Secure Digital Input and Output (SDIO), etc. The field programmable gate array only performs data caching and forwarding. The dedicated data pre-processing module may effectively improve data pre-processing efficiency, and reduce FPGA development difficulty, thereby improving the overall efficiency of the system.

In the embodiments of the present application, the accelerator device writes the storage information of the application data packet to be transmitted into the descriptor, DMA transmission is initiated by the host, and the corresponding memory space is applied according to the storage information in the descriptor without creating a large amount of memory space in advance, such that the requirement for CPU performance is reduced, and meanwhile, the real-time performance of data transmission may be ensured. Thus, it can be seen that, the embodiments of the present application avoid resource waste during a direct memory access transmission process.

An application embodiment provided in the present application, which is a data processing and transmission system based on an FPGA accelerator, will be introduced below. The system is designed for parallel application scenarios such as multi-channel ADC conversion, multi-channel image input, etc. First, the caching module receives data, and then performs data pre-processing, such as filtering processing, image decompressing and compressing, etc. The data pre-processing module may effectively reduce data processing pressure of the CPU. After being pre-processed, the data is temporarily stored in the FPGA accelerator DDR. Then, the data transmission control module records storage information of the data in the DDR, then configures the storage information into a descriptor of DMA, and finally notifies the host side to perform a data reading operation by means of the DMA. Compared with traditional processing methods, the initiation of the DMA of data transmission is initiated by the host, so as to avoid the creation of a large amount of memory space in advance, reduce the requirement for CPU performance, and ensure the real-time performance of data transmission.

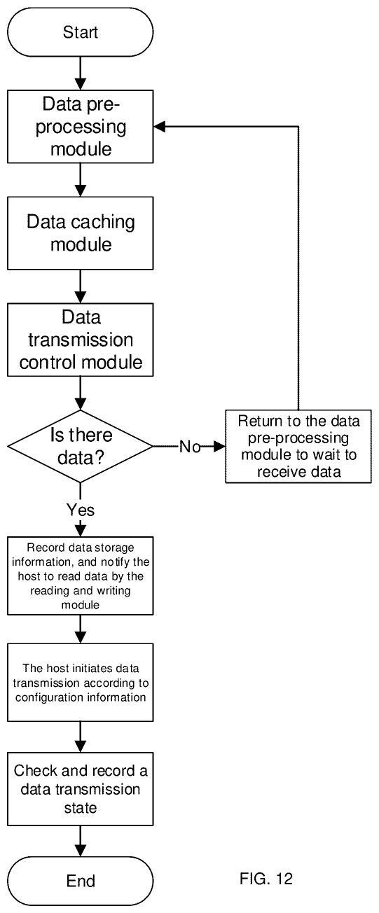

As shown in FIG. 12, the method includes the following steps.

In Step 1, the host first applies for descriptor memory space by means of DMA coherent memory, and starts the system.

In Step 2, the data pre-processing module in the FPGA accelerator receives parallel data such as multi-channel ADC, images, etc., and performs the pre-processing operation such as ADC conversion, image processing, etc. Various application processing algorithms may be developed according to different applications.

In Step 3, the data caching module caches and packs the pre-processed data, and writes the pre-processed data into the DDR.

In Step 4, the data transmission module records and controls the transmission information. If there is no data, the data pre-processing module continuously monitors data of a parallel interface, and if there is data, the data pre-processing module records the length of each data packet and the storage address of each data packet in the DDR.

In Step 5, for an application with a high real-time requirement, the data transmission module fills, into the descriptor, the length of each packet of data and the storage address information in DDR, and updates, by the reading and writing module, the number of the available descriptors (the count is added by one for each descriptor filled); and for an application with a low real-time requirement, the DDR is divided into blocks, every time one DDR data block is filled, the descriptor is filled, and the number of the available descriptors is updated by the reading and writing module (the count is added by one for each descriptor filled).

In Step 6, the host cyclically queries a descriptor count, if the value is not zero, it indicates that the data already exists; and then the descriptor is read back, memory is applied according to the length information in the descriptor, the address of the memory applied is filled into the descriptor, and then DMA transmission is initiated.

In Step 7, the FPGA accelerator checks and records a data transmission state, and the host waits for completion of receiving and transmission, so as to end the operation.

A data processing and transmission system based on a FPGA accelerator is designed in the embodiments of the present application. A data pre-processing module is designed to unload tasks suitable for parallel computing to the data pre-processing module, such that the workload of the CPU is reduced; an FPGA-initiated data reading mode is designed to reduce the overhead of host-side memory; based on a data interaction channel of the reading and writing module, the correctness of data transmission is ensured, and a phenomenon of data packet dropouts is avoided; thus, different data storage and transmission strategies are designed for different real-time performance of the application scenarios, thereby improving the stability of the system.

The above descriptions are merely optional implementations of the present application, but the protection scope of the present application is not limited thereto. Any variation or replacement readily envisaged by those skilled in the art within the technical scope as disclosed by the present application shall fall within the protection scope of the present application. Therefore, the protection scope of the present application shall be defined by the protection scope of the claims.

1. A method of transmitting data, applied to an accelerator device, wherein the accelerator device is connected with a host, and the method comprises:
receiving an application data packet, and storing the application data packet into a storage device;
recording storage information of the application data packet, wherein the storage information comprises a size of the application data packet and a storage address of the application data packet in the storage device;
writing the storage information of the application data packet into a descriptor, such that the host applies for memory according to the storage information in the descriptor, and fills an address of the memory applied into the descriptor to initiate direct memory access transmission; and
transmitting, through the direct memory access transmission, the application data packet in the storage device to the host according to the address of the memory in the descriptor filled by the host.

2. The method of transmitting data according to claim 1, wherein the receiving an application data packet, and storing the application data packet into a storage device comprises:
receiving an application data packet;
pre-processing the application data packet, wherein the pre-processing comprises any one or any combination of analog-to-digital conversion, data filtering, and image decompression; and
storing the pre-processed application data packet into the storage device.

3. The method of transmitting data according to claim 2, wherein the receiving an application data packet comprises: receiving application data packets through a plurality of data channels; and
the pre-processing the application data packet comprises: pre-processing the application data packets, received through the plurality of data channels, in parallel by a plurality of data pre-processing modules.

4. The method of transmitting data according to claim 1, wherein the writing the storage information of the application data packet into a descriptor, such that the host applies for memory according to the storage information in the descriptor, and fills an address of the memory applied into the descriptor to initiate direct memory access transmission comprises:
determining a target descriptor among descriptors whose states are in an idle state, writing the storage information of the application data packet into the target descriptor, and modifying a state of the target descriptor to an occupied state, such that the host applies for the memory according to the size of the application data packet in the target descriptor, and fills the address of the memory applied into the target descriptor to initiate the direct memory access transmission.

5. The method of transmitting data according to claim 4, wherein after transmission of the application data packet is completed, the host modifies the state of the target descriptor to the idle state.

6. The method of transmitting data according to claim 5, wherein after modifying the state of the target descriptor to the occupied state, the method further comprises:
updating a descriptor count, and transmitting the descriptor count to the host, wherein the descriptor count is configured to describe a number of descriptors whose states are in the occupied state.

7. The method of transmitting data according to claim 6, wherein the host cyclically queries the descriptor count, if the descriptor count is not zero, the host reads the target descriptor, and performs a step of applying for the memory according to the size of the application data packet in the target descriptor; and
after the host modifies the state of the target descriptor to the idle state, the host updates the descriptor count according to the number of descriptors whose states are in the occupied state.

8. The method of transmitting data according to claim 1, wherein the writing the storage information of the application data packet into a descriptor comprises:
after receiving each application data packet and storing the each application data packet into the storage device, writing the storage information of the each application data packet into the descriptor.

9. The method of transmitting data according to claim 1, wherein the storage device is divided into a plurality of storage blocks;
the storing the application data packet into the storage device comprises: sequentially storing application data packets into the storage blocks in the storage device; and
the writing the storage information of the application data packet into a descriptor comprises: after filling of each storage block is completed, writing, into the descriptor, the storage information of the application data packet in the filled storage block, wherein the storage information of each application data packet corresponds to one descriptor.

10. The method of transmitting data according to claim 1, wherein the accelerator device comprises a field programmable gate array and the storage device, the field programmable gate array comprises a data caching module, a data transmission control module, a storage controller, a reading and writing module, and a direct memory access module;
the data caching module is configured to cache the application data packet received;
the storage controller is configured to store the application data packet cached into the storage device;
the data transmission control module is configured to record the storage information of the application data packet, and write the storage information of the application data packet into the descriptor through the reading and writing module;
the reading and writing module is configured to perform information transmission with the host; and
the direct memory access module is configured to transmit the application data packet in the storage device to the host according to the address of the memory in the descriptor filled by the host.

11. The method of transmitting data according to claim 10, wherein the field programmable gate array further comprises a data pre-processing module, and the data pre-processing module is configured to pre-process the application data packet received.

12. The method of transmitting data according to claim 10, wherein the accelerator device further comprises a data pre-processing module independent of the field programmable gate array; the data pre-processing module is connected with the field programmable gate array; and the data pre-processing module is configured to pre-process the application data packet received.

13. An apparatus of transmitting data, applied to an accelerator device, wherein the accelerator device is connected with a host, and the apparatus comprises:
a storage module, configured to receive an application data packet, and store the application data packet into a storage device;
a recording module, configured to record storage information of the application data packet, wherein the storage information comprises a size of the application data packet and a storage address of the application data packet in the storage device;
a writing module, configured to write the storage information of the application data packet into a descriptor, such that the host applies for memory according to the storage information in the descriptor, and fills an address of the memory applied into the descriptor to initiate direct memory access transmission; and
a transmission module, configured to transmit, through the direct memory access transmission, the application data packet in the storage device to the host according to the address of the memory in the descriptor filled by the host.

14. An accelerator device, comprising:
a storage device, configured to store a computer program; and
a processor, configured to implement, when executing the computer program, steps of the method of transmitting data according to claim 1.

15. A method of transmitting data, applied to a host, wherein the host is connected with an accelerator device, and the method comprises:
acquiring a descriptor, and applying for memory according to storage information in the descriptor, wherein the storage information comprises a size of an application data packet to be transmitted and a storage address of the application data packet in a storage device of the accelerator device;
filling an address of the memory applied into the descriptor to initiate direct memory access transmission; and
receiving the application data packet sent by the accelerator device.

16. The method of transmitting data according to claim 15, wherein before the acquiring a descriptor, the method further comprises:
querying a descriptor count, and if the descriptor count is not zero, turning to the step of acquiring the descriptor, and applying for the memory according to the storage information in the descriptor.

17. The method of transmitting data according to claim 15, wherein before the acquiring a descriptor, the method further comprises:
applying for descriptor storage space by accessing the applied memory through direct memory access.

18. A host, comprising:
a storage device, configured to store a computer program; and
a processor, configured to implement, when executing the computer program, steps of the method of transmitting data according claim 15.

19. A non-volatile computer-readable storage medium, wherein the non-volatile computer-readable storage medium stores a computer program thereon, the computer program, when executed by a processor, implements steps of the method of transmitting data according to claim 1.

20. A system of transmitting data, comprising the accelerator device according to claim 14 and the host according to claim 18, wherein the host is connected with the accelerator device.
